(19) United States
(12) Patent Application Publication
(10) Pub. No.: US 2006/0148570 A1
(43) Pub. Date: Jul. 6, 2006

(54) Portable data techniques for gaming devices

(76) Inventor: Samuel Leopold, Chicago, IL (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/027,290

(22) Filed: Dec. 30, 2004

(51) Int. Cl. A63F 13/00

(52) U.S. Cl. 463/43

(57) ABSTRACT

Portable data for gaming devices is presented. Data is downloaded from a first device to a portable device. The data is uploaded from the portable device to a gaming device. In response to the uploaded data, the gaming device presents a portion of the data on a display monitor associated with the gaming device. Alternatively, the gaming device, in response to the uploaded data, produces results data, and the results data is transferred from the gaming device to the portable device.

### FIELD

The invention relates generally to data communication, and more particularly to techniques for communicating portable data to gaming devices.

### BACKGROUND

The gaming industry has been exploding with growth in recent years. As a result, a variety of new types of gaming devices or machines have emerged in the marketplace. These devices are increasingly equipped with processors and memory and run a variety of software applications.

Thus, when a machine malfunctions in some manner or requires some type of servicing to acquire diagnostic information, a technician will typically visit the gaming device and perform the desired operations. In most cases, the gaming devices are not equipped with technical data that may assist the technician in servicing the gaming device. Consequently, the technician usually brings a laptop to the site and a variety of compact disks (CDs). The CDs have the technical data that the technician needs to reference when servicing the gaming device.

A technician's procedure for acquiring desired technical information for a particular gaming device is not optimal because the laptop is bulky and the CDs can be lost or there may be a plethora of CDs, such that locating a desired one takes time and may be frustrating. Moreover, the more time that it takes for a technician to properly service a malfunction gaming device, the more revenue that may be lost while the gaming device is out of service. Therefore, rapid problem resolution and servicing are vital to gaming enterprises.

Therefore, there is a need for an improved technique to acquire desired data and to process or view that data at a gaming device's location.

### SUMMARY

In various embodiments, portable data for gaming devices is provided. Data from a portable device is uploaded to a gaming device. In response to the uploaded data, the gaming device presents at least a portion of the data on a display monitor associated with the gaming device. In an embodiment, the gaming device may also produce results data in response to the uploaded data and transfer the results data to the portable device.

### BRIEF DESCRIPTION OF THE DRAWINGS

FIG. 1 is a diagram of method for uploading data to a gaming device from a portable device, according to an example embodiment.

FIG. 2 is a diagram of method for downloading data to a portable device and uploading data from the portable device to a gaming device, according to an example embodiment.

FIG. 3 is a diagram of a portable data gaming system, according to an example embodiment.

FIG. 4 is a diagram of a portable device, according to an example embodiment.

### DETAILED DESCRIPTION

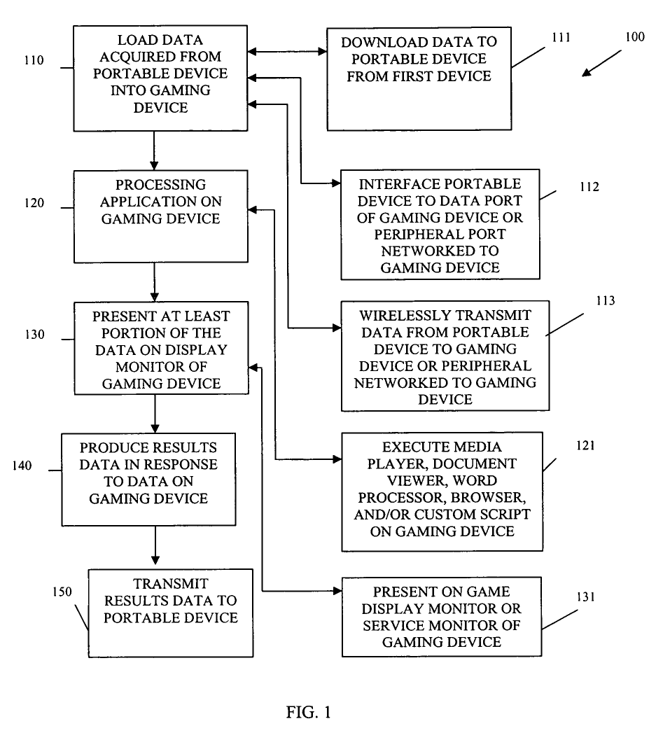

FIG. 1 is a diagram of method 100 for uploading data to a gaming device, according to an example embodiment. The method 100 (herein after “portable data service”) is implemented in a machine-accessible and readable medium. In an embodiment, the portable data service executes on a gaming device and interfaces with a portable device to acquire portable data for processing.

As used herein a “gaming device” refers to a machine that plays or executes games associated with betting. By way of example only, a gaming device may be a slot machine, video poker, and the like. Moreover, a single gaming device may be capable of executing one to many betting games.

The gaming device may include one or more display monitors, where at least one display monitor is used to present betting games to betters. In an embodiment, the gaming device may include an additional display monitor situation inside a compartment of the gaming device and used by technicians that service the gaming device.

The gaming device is also equipped with one or more ports for receiving and communicating data. In an embodiment, at least one port is enabled to wirelessly receive and transmit data to and from the gaming device. In another embodiment, at least one port is enabled for network communication between the gaming device and one or more other devices or peripheral devices. In yet another embodiment, at least one port is associated with media bay that accepts removable media, such as memory sticks, smart media, compact flash, and other types of removable media.

The portable device may be a removable memory module or may be a portable processing device. For example, the portable device may be a memory stick, smart media, compact flash, and the like. Alternatively, the portable device may be a personal digital assistant (PDA), a phone, intelligent apparel (e.g., watch, etc.), a digital tablet, etc.

Data refers to technical information relevant to the gaming device. This may include, by way of example only, instructional information designed to assist a technician that services the gaming device or diagnostic tests designed to execute on the gaming machine and produce results data for the technician. The data may be in a variety of formats, such as hypertext format, word processing format, video and/or audio format, image and/or graphic format, and/or executable format.

In some cases, the application used to display the data, such as a media player, a word processor, image viewer, and the like resides within the gaming device. In other cases, the application used to display the data is included with the data, such that the gaming device can install it and view the data on demand.

Now referring to FIG. 1, at 110, the portable data service loads data acquired from a portable device into the gaming device. In an embodiment, at 111, the data may have been initially acquired by the portable device from a first device. That is, the portable device may have previously downloaded the data from a variety of devices, such as a personal computer, a server, a data warehouse, database, directory, etc.

The data may be loaded in a variety of manners. For example, at 112, the data may be loaded from the portable device by interfacing the portable device to a data port directly attached to the gaming device. In this example, the data port may be a media bay or docking station to which the portable device plugs into. In another example, at 112, the portable device may interface to a peripheral port which is networked to the gaming device. Thus, once the portable device is in communication with the network, the portable data service acquires and loads the data into the gaming device. In still another example, at 113, the portable device may wirelessly transmit the data to a wireless communication port directly associated with the gaming device or to a wireless communication port associated with a peripheral device that is networked to the gaming device.

Once the data is loaded into the gaming device, at 120, the portable data service initiates the processing of an application or service on the gaming device. The application is supplied the data. In an embodiment, at 121, this may entail initiating a media player, a document viewer, a word processor, a browser, and/or a custom script processor (in cases where the data is a diagnostic test and in an executable format).

As a result of processing the application, at 130, at least a portion of the data is presented on a display of the gaming device. This permits a technician associated with the gaming device who is equipped with the portable device to rapidly interface with the gaming device via the portable device to upload the data and then to view that data or selective portions of that data on a display monitor of the gaming device.

In an embodiment, at 131, the selective portions of the data may be presented on a display of the gaming device that is also used by betters to view betting games. Alternatively, the selective portions of the data may be presented on a service display which is an additional monitor that is located inside the gaming device and accessed by the technician when desired.

In some embodiments, at 140, when the data uploaded to the gaming device is a diagnostic test, the execution of that test on the gaming device may produce results data on the gaming device. The results data may then be transmitted, at 150, back to the portable device for subsequent consumption or use. A technician may then transport the results data via the portable device and subsequently upload the results data to another device or data store.

It is now appreciated, how data may be portably communicated from a portable device directly to a gaming device, where the data may be viewed on a monitor associated with the gaming device and evaluated by a technician. These techniques improve the efficiency of the technician associated with servicing the gaming device and reduce the amount of equipment and materials that the technician may have to transport to the gaming device's location for a service call. In fact, in an embodiment, the portable device may be a memory stick that is affixed to a keychain of the technician. The memory stick may be plugged into a bay of the gaming device and the processing of the portable data service as depicted in FIG. 1 commences in the manners discussed above. This streamlines and simplifies a technician's interactions during a service call to the gaming device and improves his/her efficiency.

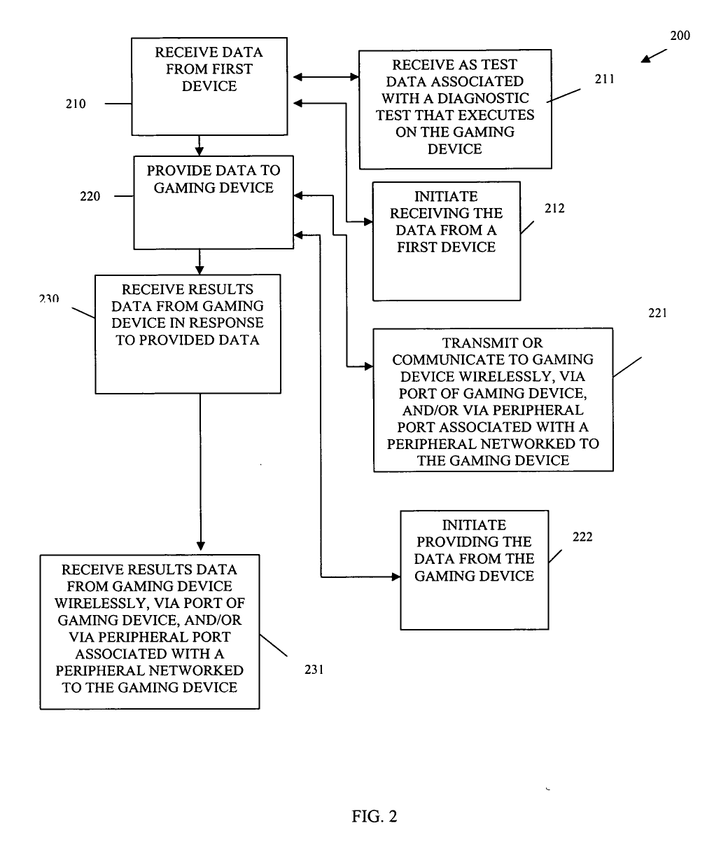

FIG. 2 is a diagram of a flowchart for a method 200 that downloads and uploads data to and from a portable device. The method 200 (hereinafter referred to as “portable device service”) is implemented in a machine-accessible and readable medium. In an embodiment, the portable device service may be implemented in the portable device. In an alternative embodiment, the portable device service may be implemented in a gaming device and one or more other devices and processed when the portable device is accessed by the gaming device and the one or more other devices. This latter embodiment may be deployed when the portable device is a memory stick (e.g., keychain memory module, etc.) or other types of removable media.

At 210, the portable device service receives data from a first device. The data is technical help data or a diagnostic test. The data relevant to a gaming device's operation, maintenance, etc. The format of the data may be associated with a word processor, a browser, a media player, a document viewer, a spreadsheet, a script language, and the like. After the data is received, it is recorded or stored on or within the portable device.

In an embodiment, at 211, the data is received as test data associated with a diagnostic test that is designed or adapted to subsequently execute on a gaming device once the data is uploaded to the gaming device from the portable device. In still another embodiment, at 212, the receipt of the data, at 210, is initiated by a first device. In this embodiment, at 212, the portable device may be a portable and removable memory module, such as a keychain memory stick or module.

After the data is received or loaded to a portable device that data is subsequently uploaded to a gaming device for consumption. Accordingly, at 220, the portable device service provides the data to the gaming device. This occurs when the technician interfaces the portable device to the gaming device. The portable device may be interfaced to the gaming device in a variety of manners.

For example, at 221, the data may be provided by transmitting or communicating the data to the gaming device. For instance, the portable device may also include a processor and be capable of wirelessly transmitting the data from the portable device directly to a wireless communication port of the gaming device or indirectly to the gaming device via a wireless peripheral communication port associated with a peripheral device that is networked to the gaming device. In another situation, the portable device may directly plug into a media port or bay associated with the gaming device or directly plug into a media port associated with a peripheral device which is networked to the gaming device.

In an embodiment, at 222, the receipt of the results data may be initiated by the gaming device. This occurs when the portable device is a memory stick or module which lacks a processor. In this manner, the portable device service may be implemented and processed by the gaming device and one or more other devices in cooperation with one another to acquire and store data on the portable device.

At 230, the portable device service receives results data from the gaming device. The gaming device produces the results data in response to the provided data. The results data may be diagnostic information or metrics obtained from the gaming device. The results data is stored on the portable device after the receipt and may be transported and subsequently uploaded to other devices or data stores.

Again, the results data may be received from the gaming device in a variety of manners. Some example techniques are presented at 231. For example, the gaming device may wirelessly transmit the results data to the portable device in cases where the portable device is equipped with a processor and wireless capabilities. As another example, the gaming device may directly write the results data to the storage of the portable device in cases where the portable device is plugged into or directly connected to the gaming device or to a peripheral device networked to the gaming device.

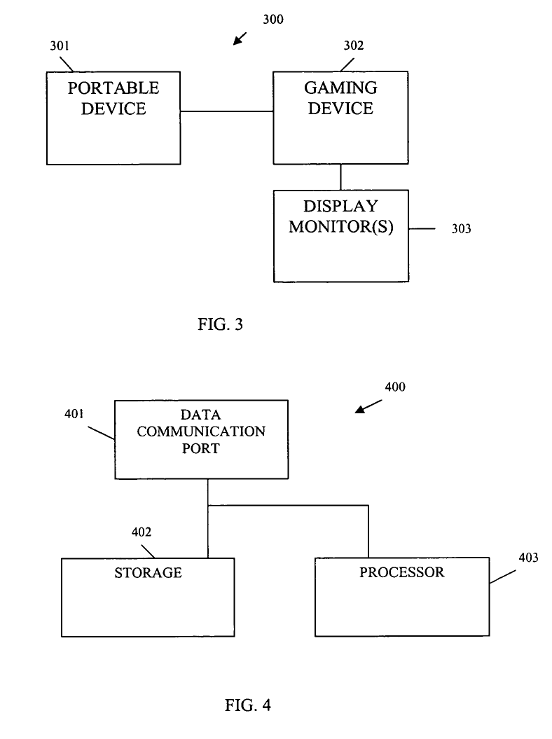

FIG. 3 is a diagram of a portable data gaming system 300. The portable data gaming system is implemented in a machine-accessible and readable medium. In an embodiment, the portable data gaming system 300 implements, among other things, the methods 100 and 200 of FIGS. 1 and 2.

The portable data gaming system 300 includes a portable device 301 and a gaming device 302. In an embodiment, the portable data gaming system 300 also includes one or more display monitors integrated into or in direct communication with the gaming device 302.

The portable device 301 includes storage for housing data acquired from one or more first device and for housing results data acquired from the gaming device 302. The storage also permits the data and the results data to be acquired from the first devices and the gaming device 302. In an embodiment, the portable device 301 is also equipped with a processor and memory. In this embodiment, the portable device 301 may be a PDA, intelligent apparel (e.g., watch, etc.), a digital tablet, and the like. In an alternative embodiment, the portable device 301 is a memory device or module, such as a memory card, stick, or keychain.

The gaming device 302 is adapted to play or execute betting games. For example, the gaming device 302 may be a slot machine, video poker machine, etc. The gaming device 302 is also adapted to acquire data from the portable device 301 and to communicate or store results data on or within the portable device 301. The gaming device 302 is further adapted to display at least some portions of acquired data on a display monitor 303 connected, integrated, or interfaced to the gaming device 302.

The display monitor 303 that presents the portions of the data, which was acquired from the portable device 301, may be the same monitor 303 that a better views when playing betting games on the gaming device. Alternatively, the monitor 303 that presents the portions of the data may be an additional monitor 303 located or situation inside the gaming device 302 and accessed by service technicians. Thus, in some cases, the gaming device 302 is equipped with more than one monitor 303.

In an embodiment, the portable device 301 is adapted to wirelessly communicate the data located within its storage to the gaming device 302. This may occur via wireless communication ports situated on both the portable device 301 and the gaming device 302. In some instances, the portable device 301 may wirelessly transmit the data to a peripheral wireless communication port that is associated with a peripheral device that is networked to the gaming device 302.

In another embodiment, the portable device 301 may plug into a data port situated on the gaming device 302 for purposes of transmitting the data in its storage to the gaming device 302. In another arrangement, the portable device 301 may plug into a data port situated on a peripheral device that is networked to the gaming device. In still other embodiments, the portable device 301 may connect via a Universal Serial Bus (USB) wire. In these instances, the gaming device 302 includes a USB port and the portable device 301 either includes a USB port or plugs into a USB reading device which includes a USB port.

The gaming device 302 during operation interfaces with the storage of the portable device 301 for purposes of acquiring the data. This operation is initiated by a technician. The data is initially acquired in the storage of the portable device 301 from one or more other devices, such as PCs, servers, data warehouses, databases, directories, etc. Once the data is loaded into the gaming device 302, an application may be executed that presents the data on a display monitor 303 of the gaming device 302. In some embodiments, the data is an executable script that performs some diagnostic test or other customized operation on the gaming device 302. In these cases, as a result of executing the script the gaming device produces results data. The results data may then be communicated to the portable device 301.

FIG. 4 is a diagram of a portable device 400, according to an example embodiment. The portable device 400 is implemented in a machine-accessible and readable medium. The portable device 400 facilitates the communication of data to a gaming device and captures results data produced by a gaming device.

The portable device 400 includes a data communication port 401 and storage 402. In an embodiment, the portable device 400 also includes a processor 403 and/or memory (not shown in FIG. 4).

The portable device 400 may be a passive device, which means that other devices act upon it to acquire or record data in its storage 402. In this embodiment, the portable device 400 may be a memory device or module, such as a memory keychain, memory stick, and the like. Alternatively, the portable device 400 may be an active device, such as when the portable device 400 is equipped with a processor 403. A portable device 400 equipped with a processor 403 and/or memory may be a phone, a PDA, intelligent apparel (e.g., watch, etc.), a digital tablet, etc.

The data communication port 401 includes hardware and/or software that permit the storage 402 of the portable device 400 to be accessed. Some example hardware arrangements may include pins or connections associated with serial, parallel, and/or USB connections. The hardware arrangements may also include receivers and/or transmitters for facilitating wireless communications. Some example software arrangements may include device drivers associated with accessing the hardware components. Software data communication ports 401 may be used when the portable device 400 is equipped with a processor 403.

The storage 402 may be optical or magnetic and houses data acquired from first devices and results data produced by gaming devices. Access to the storage 402 is acquired via the data communication port 401. Data may be written and read from the storage.

In an embodiment, the data communication port 401 is adapted to directly connect to a media bay or docking station associated with a gaming device. In another embodiment, the data communication port 401 is adapted to connect via a USB cable to a USB port associated with the gaming device. In still other embodiments, the data communication port 401 is adapted to directly connect of connect via cable to a peripheral device's port, where the peripheral device is networked to the gaming device. In yet more embodiments, where the portable device 400 is equipped with a processor 403, the data communication port 401 may be used to wirelessly transmit data from the storage 402 or to wirelessly receive results data for purposes of writing the results data to the storage 402.

In an embodiment, the portable device 400 is a keychain memory module adapted to attach to a keychain for transport. In another embodiment, the portable device 400 is a PDA or phone.

During operation, the portable device 400 acquires data from one or more first devices. The data is related to technical help or diagnostics associated with a gaming device. The first device may be a server, PC, data store, etc. A technician selects and downloads the data from the first device to the storage 402 of the portable device 400 via the data communication port 401. Next, the technician goes to the site of the gaming device and uploads the data from the storage 402 to the gaming device via the data communication port 401. The gaming device, in response to the data, presents portions of the data on a display monitor for the technician to consume and to view. Actions of the technician while interacting with the gaming device and viewing the data may result in the gaming device producing results data. The results data may be written to the storage 402 of the portable device 400 via the data communication port 401.

It has now been demonstrated how technician may utilize a portable device to move data to and from a gaming device. These techniques streamline the interactions of a technician that services the gaming device and reduces the amount of materials and equipment that the technician may need when he/she visits the site of the gaming device, which is being serviced.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A method, comprising:
loading, by a gaming device, data acquired from a portable device;
processing an application on the gaming device to display at least a portion of the data; and
presenting the portion on a display monitor associated with the gaming device.

2. The method of claim 1, wherein loading further includes interfacing the portable device having the data to at least one of a data port associated with the gaming device and a peripheral port associated with a peripheral device which is networked to the gaming device,.

3. The method of claim 1, wherein loading further includes wirelessly transmitting the data from the portable device to at least one of the gaming device or a peripheral device networked to the gaming device.

4. The method of claim 1, wherein processing further includes executing on the gaming device at least one of a media player application, a word processing application, a browser application, a document viewer application, and a custom script that takes the data as input and presents the portion of the data on the display monitor.

5. The method of claim 1, wherein presenting further includes presenting the portion of the data on the display monitor, wherein the display monitor is at least one of a game monitor used by the gaming device to display game images and videos to betters and a service monitor accessed by technicians that service the gaming device.

6. The method of claim 1 further comprising:
producing results data associated with processing the data; and
transmitting the results data to the portable device.

7. The method of claim 1 further comprising, downloading the data to the portable device before loading the data to the gaming device.

8. A method, comprising:
receiving data from a first device;
providing the data to a gaming device; and
receiving results data from the gaming device, wherein the results data is produced by the gaming device in response to the provided data.

9. The method of claim 8, wherein receiving the data further includes receiving the data as test data associated with a diagnostic test that executes on the gaming device.

10. The method of claim 8, wherein providing the data further includes wirelessly transmitting the data to the gaming device.

11. The method of claim 8, wherein providing the data further includes directly transmitting the data via a port associated with the gaming device.

12. The method of claim 8, wherein providing the data further includes indirectly transmitting the data via a port associated with a peripheral device networked to the gaming device.

13. The method of claim 8, wherein receiving the results data further includes receiving the results data from the gaming device from at least one of a wireless communication port, a wired port, or a peripheral port networked to the gaming device.

14. The method of claim 8, wherein receiving the data is initiated by the first device.

15. The method of claim 8, wherein providing the data is initiated by the gaming device.

16. A system, comprising:
a portable device; and
a gaming device, wherein the portable device is adapted to record data from one or more other devices and the gaming device is adapted to acquire the data from the portable device and present at least a portion of the data on a display associated with the gaming device.

17. The system of claim 16, wherein the portable device is adapted to wirelessly communicate the data to the gaming device.

18. The system of claim 16, wherein the portable device is adapted to communicate the data to the gaming device by directly connecting to at least one of a port associated with the gaming device and a port associated with a peripheral device networked to the gaming device.

19. The system of claim 16, wherein the display is adapted to present gaming data associated with betting games executed on the gaming device.

20. The system of claim 16, wherein the display is one of at least two displays associated with the gaming device, and situated on an inside portion of the gaming device.

21. The system of claim 16, wherein the gaming device is adapted to produce results data associated with the gaming device and to store the results data on the portable device.

22. A portable device, comprising:
a port adapted to interface with a first device; and
storage adapted to receive data from the first device through the port, and wherein the port is further adapted to interface with a gaming device and transfer the data from the storage.

23. The portable device of claim 22, wherein the portable device is a memory stick and further adapted to affix to a keychain for transport.

24. The portable device of claim 22, wherein the port is adapted to directly connect to gaming device port associated with the gaming device.

25. The portable device of claim 22, wherein the port is adapted to directly connect to a peripheral port associated with a peripheral networked to the gaming device.

26. The portable device of claim 22, wherein the port is further adapted to acquire results data from the gaming device and store the results data within the storage.
